(19) United States
(12) Patent Application Publication
(10) Pub. No.: US 2005/0267945 A1
(43) Pub. Date: Dec. 1, 2005

(54) Systems and methods for deterring internet file-sharing networks

(76) Inventors: Ori Cohen, Palo Alto, CA (US); Stanislav Khirman, Sunnyvale, CA (US)

Correspondence Address: STRATEGIC PATENTS P.C.., C/O PORTFOLIOIP, P.O. BOX 52050, MINNEAPOLIS, MN, 55402, US

(21) Appl. No.: 11/102,546

(22) Filed: Apr. 8, 2005

Related U.S. Application Data
(60) Provisional application No. 60/560,210, filed on Apr. 8, 2004.

(51) Int. Cl. G06F 15/167

(52) U.S. Cl. 709/215

(57) ABSTRACT

Provided herein are methods and systems to prevent the illegal sharing of digital content by deterring or disrupting file sharing activity. In embodiments methods and systems are provided for responding to user queries in a file sharing network with information that allows users to attempt to download protected digital content but does not allow users access to the protected digital content.

### RELATED APPLICATIONS

This application claims the benefit of U.S. Prov. App. No. 60/560,210, filed Apr. 8, 2004, incorporated herein by reference in its entirety.

### BACKGROUND

1. Field

This invention relates to deterrence of file sharing, in particular the illegal sharing of copyrighted or other proprietary content among users on file sharing networks.

2. Description of Related Art

File sharing networks such as Internet peer-to-peer (P2P) networks impair legitimate commercial activity by the owners and distributors of digital media. File sharing networks enable users to locate and exchange files in simple, convenient, fast, and intuitive ways. As a result, millions of users now exchange media such as pirated songs, movies, photographs, and software over file sharing networks. Also, a growing number of consumers regard this type of file sharing as an acceptable activity, creating even greater enforcement challenges for owners of media rights. File sharing applications have become so popular that on some Internet Service Provider networks they account for more than half of all network traffic. As compression techniques improve and retail data rates increase, the difficulties faced by owners of rights in various media will continue to grow.

Content owners have sought to address the resulting media theft with a variety of tools including litigation, education, legislation, and anti-piracy technologies. One general technological strategy focuses on disrupting the file sharing networks used to unlawfully swap and distribute proprietary media through techniques such as interdiction, spoofing, queuing, and so on. As a significant disadvantage, these techniques generally rely on Internet Piracy Prevention (IPP) servers having a static IP address, or an identifiable IP sub-network. Thus, it becomes relatively straightforward to identify IPP servers and ultimately to exclude them from a network of illegal file swappers.

The Internet has a number of protocols that are directed at the sharing of files over P2P networks, but there are only a few applications for disrupting the illegal distribution of copyrighted materials. Industry capabilities for prevention of illegal file sharing generally relate to flooding P2P networks with corrupted files, generating fake hashes, and/or “spoofing” either high bandwidth or good file quality (bit-rate encoding) using a high number of servers and files to create a relatively high provider ranking, thus drawing users to a corrupted file that is passed off as the desired file. These technologies rely on a brute force method of providing significant indicators of a desired file. Even when successfully flooding the P2P network with these significant indicators of the desired file, the fixed servers attempting the disruption can be identified and therefore avoided when attempting a transfer of copyrighted content.

There remains a need for improved methods and systems for deterring the illegal transmission of copyrighted content.

### SUMMARY

Provided herein are methods and systems to prevent the illegal sharing of digital content by disrupting file sharing activity. In embodiments, when a user attempts to download protected content, such as a music or video file, the user may be presented with a set of results that make it appear that the user can access the protected content, when in fact attempting to access the content will result in some other event, such as downloading only partial or corrupted content, downloading different content, triggering an alert to a copyright owner or manager, or sending a message to the user about the attempt to download the protected content.

In certain embodiments, agent software may be distributed to users, who may be provided with incentives to download and run the software. The agent software joins a file sharing network and engages in disruptive activity, either autonomously or under control of a source manager. A distributed approach to disruption activities can make disruption activities more difficult to detect and thus more difficult to circumvent by network users seeking to share or exchange protected media.

In one aspect, disclosed herein are systems and methods for attracting participants in a file sharing network, including establishing a plurality of distributed agents within a file sharing network; receiving a request for protected media at one of the plurality of distributed agents from a participant; and controlling the one of the plurality of distributed agents to respond to the request with favorable information concerning the protected media.

The file sharing network may be a peer-to-peer network. The favorable information may indicate an availability of the protected media at one or more other locations within the file sharing network, an availability of the protected media at the particular one of the plurality of distributed agents, an availability of an alternative to the protected media, and/or an indication of good quality for one or more of a set of network connections, a file characteristic, or a responsiveness to the request. The file and/or source information may include information adapted to rank highly in a ranking of search results by the participant.

The protected media may be protected by copyright. The request may include at least one of a search request, a download request, or a query. The favorable information may be adapted to attract other participants to one or more of the distributed agents. The favorable information may include information intended to be distributed to other participants through the file sharing network. The method may be offered as a file sharing deterrent service, the favorable information being specified by a customer of the file sharing deterrent service. The response may include coordination of activity by two or more of the distributed agents.

In another aspect, systems and methods for deterring sharing of protected media in a file sharing network disclosed herein may include establishing a plurality of distributed agents within a file sharing network; initiating a search for protected media from at least one of the plurality of distributed agents; and upon identification of protected media at a participant location, initiating activity within the file sharing network to diminish availability of the protected media at the participant location.

The activity may include flooding the participant with search requests related to the protected media. The activity may include flooding the participant with download requests related to the protected media. The method may include coordinating the activity among more than one of the plurality of distributed agents.

In another aspect, a response may be delayed by providing an excessive list of bogus pointers to requested media sources. A requester will spend a significant amount of time and network resources to locate a working source in the “noise” background.

In another aspect, a method or system for attracting participants in a file sharing network may include establishing a plurality of distributed agents within a file sharing network; receiving a request for protected media at one of the plurality of distributed agents from a participant; and controlling the one of the plurality of distributed agents to respond to the request by redirecting the request to another location.

The other location may be a legitimate source of the protected media. The method or system may further include charging a fee for referring the participant to the other location. The other location may be an Internet site, another one of the plurality of agents, and/or a file server.

In another aspect, a method or system for attracting participants in a file sharing network may include establishing a plurality of distributed agents within a file sharing network; receiving a request for protected media at one of the plurality of distributed agents from a participant; and transmitting other media to the participant.

The method or system may include dynamically generating the other media. The other media may direct the participant to a legitimate source of the protected media. The other media may be predetermined media stored at the one of the plurality of agents. The other media may be adapted to receive a high ranking in a search request for the protected media. The other media may include one or more indicia that it is the protected media. The one or more indicia may include a hash value.

In another aspect, a method or system for protecting content in a file sharing network may include receiving a request from a participant in a file sharing network at one of a plurality of distributed agents; analyzing the request to determine a corresponding hash value for content responsive to the request; simulating a file with the corresponding hash value; and presenting the simulated file to the participant for download.

Simulating the file may include using signaling of the file sharing network to indicate presence of the file at one or more of the plurality of distributed agents. The simulated file may be an actual file on one or more of the distributed agents. The simulated file may not exist or may be dynamically generated. The simulated file may include an object containing an instruction. The instruction may direct the participant to a legitimate source for the file. The method or system may include charging a fee for directing the participant to the legitimate source.

In another aspect, a method or system of protecting content in a file sharing network may include receiving a request for protected media from a participant in a file sharing network at one of a plurality of distributed agents and delaying a response to the request.

In another aspect, a method and system of delaying a response may provide an excessive list of bogus pointers to requested media sources. Requester may spend a significant amount of time and network resources to locate a working source in the “noise” background.

The response may be delayed by the one of the plurality of distributed agents that received the request. Delaying may include forwarding the request to another one of the plurality of distributed agents, the other one of the plurality of distributed agents configured to queue the request without responding. The method or system may include simulating the presence of a high quality source for the protected media and may also include simulating one or more of a good connection bandwidth, a good file quality, a desirable file size, a short queue, or a good data transfer rate.

In another aspect, a system or method for disrupting file sharing of protected media may include distributing agent software to a plurality of devices, the agent software configured to control a network device to participate in a file sharing network, and to control the network device to respond to remote commands relating to participation of the network device in the file sharing network; presenting a web site to customers, the web site configured to receive from a customer a specification of a deterrent campaign including a designation of protected media and one or more deterrent techniques for inhibiting sharing of the protected media through one or more file sharing networks; and charging the customer for executing the deterrent campaign and issuing commands to one or more of the network devices executing the agent software to execute the deterrent campaign within one or more of the file sharing networks.

In another aspect, a system or method for disrupting file sharing of protected media may include attracting P2P customers to paid media with build-in digital rights managements (DRM) and payment procedure, such as distributed by Microsoft® Windows media.

Charging the customer may include assessing a fee according to a number of file sharing networks designated in the deterrent campaign. Charging the customer may include assessing a fee according to a number of agents employed in the deterrent campaign. Charging the customer may include assessing a fee according to the achievement of measurable deterrent results. Charging the customer may include assessing a fee according to a number of protected works designated in the deterrent campaign. Charging the customer may include assessing a fee according to a number and type of deterrent techniques employed in the deterrent campaign. Charging the customer may include assessing a fee according to a ranking for search results provided by agents to participants in the file sharing network.

Rankings may include rankings based on one or more of bandwidth, file quality, connection quality, or responsiveness to a search request.

### FIGURES

The invention may be understood by reference to the following figures.

FIG. 1 depicts a file sharing network according to principles of the present invention.

FIG. 2 shows a file sharing network with a source manager and agents according to principles of the present invention.

FIG. 3 is a block diagram of a software architecture for use in file sharing disruption.

FIG. 4 shows a flow chart of a file sharing deterrent process using search requests received by an agent according to principles of the present invention.

FIG. 5 shows a flow chart of a file sharing deterrent process using search requests issued by an agent according to principles of the present invention.

### DETAILED DESCRIPTION

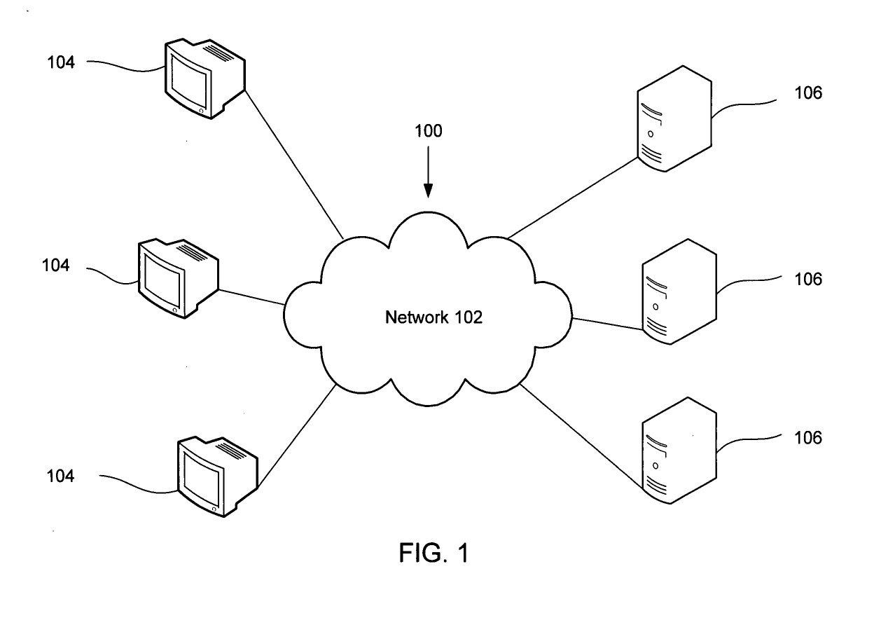

FIG. 1 shows a file sharing network according to principles of the present invention. A file sharing network 100 may include a data network 102 interconnecting one or more participants 104 and one or more servers 106 for coordinating file sharing and exchanging media. While exchange of music in the form of Motion Picture Experts Group Audio Layer 3 (mp3) files is currently popular, it will be appreciated that any number of different types of media may be transmitted in file sharing networks, including moving picture files (*.avi, *.mpg, *.mov, *.asf, *.wmv, *.dvx, *.qt, and the like) or Digital Versatile Disk files; sound files (*.wav, *.mp3, *.ra, *.ram, *.aiff, *.au, and the like) or Compact Disk files; pictures (*.jpg, *.bmp, *.png, *.tif, and the like); documents for various application programs such as word processors (e.g., Microsoft Word or Correl WordPerfect), drafting programs (e.g., Visio), presentation programs (e.g., Microsoft PowerPoint), and Portable Document Format or other document management programs; as well as the applications themselves or other standalone executables including games, application software, operating system software, and so on. All such media may be shared through a file sharing network and are intended to fall within the meaning of the term “media” as used herein, unless specifically noted otherwise. Further, protected media may be any media in which an individual or entity has a proprietary interest, such as copyright rights, that provides lawful restrictions on use, copying, sale, or distribution thereof.

A number of file sharing networks 100 are known and widely used. In embodiments, such networks are either centralized, such as Napster, and employ one or more servers 106 to index content available for download from participants 104, or they are decentralized (with decentralized networks currently becoming much more popular). In a decentralized file sharing network 100 such as a peer-to-peer network, participants 104 share search functions and content provider functions. For example, one file sharing protocol, Gnutella, coined the phrase “servelet” to denote the combined server/client functionality of a participant in a Gnutella file sharing network. Other file sharing networks 100, such as KaZaa, BitTorrent, FastTack, Warez, mp2p, filetopia, Direct Connect, winMX, soulseek, and so on, use various combinations of distributed searching techniques, storage techniques, and transport methods. It should also be appreciated that a particular protocol may be employed for a number of wholly independent file sharing networks 100, such as the Multisource File Transfer Protocol, which is used in eMule, eDonkey, and Overnet. More generally, the file sharing network 100 may be any combination of protocols and technologies useful for sharing digital content among a number of users. It will be appreciated that new protocols, permutations of old protocols, and new applications using existing protocols appear frequently. Accordingly, the identification of particular file sharing and peer-to-peer networks here should in no way limit the scope of the methods and systems described herein.

The data network 102 may include any network or combination of networks for data communication, including but not limited to the Internet, the Public Switched Telephone Network, private networks, local area networks, wide area networks, metropolitan or campus area networks, wireless networks, cellular networks, and so on, as well as any combination of these and any other logical or physical networks that might be used with the same, such as virtual private networks formed over the Internet. More generally, the data network 102 may include any network or combination of networks suitable for forming data connections among devices and establishing a file sharing network 100 as described herein.

Each participant 104 may be any device connected to the data network 102 and participating in the file sharing network 100 described herein, including, for example, any computer, laptop, notebook, personal digital assistant, network-attached storage, cellular phone, media center, set-top box, or other device or combination of devices. In embodiments, a participant 104 may index, store, transmit, receive, and/or analyze media according to the protocol of the file sharing network 100. In one common configuration, a participant 104 will employ application software for participating in a particular file sharing network 100; however, other configurations are also possible, such as a web browser plug-in. Operation of participants 104 in a file sharing network 100 varies from network to network, and from protocol to protocol, and new protocols emerge regularly. As such, the following general description provides context only and in no way limits the meaning of file sharing networks 100 as they relate to the systems described herein.

Typically, participants 104 in a peer-to-peer network can form direct interconnections between locations identified by an Internet Protocol (IP) address or other address. A participant 104 may designate a path such as a file, directory, drive, or device for sharing or uploading local files and another path for storing or downloading remote files, which may be the same as or different from the shared file path. A participant 104 may include search software through which a user can enter queries which may be composed of any conventional search parameters including keywords, wildcards, Boolean operators, file characteristics (length, size, audio or video quality, compression ratio, etc.), connection characteristics (bandwidth, latency, duration of availability, users in queue for a particular file source or a particular file, data transfer rates for a participant 104, etc.), file metadata (author, album, length, owner, tracks, notices, hashes, etc.), and so on. Other participants 104 may receive the query and either forward the query to other participants 104 in the file sharing network 100 or search local files to determine whether responsive content is available, or both. Once responsive content has been located, a direct connection between a requesting participant 104 and the responding participant 104 through the data network 102 may be established to transfer content to the requester. A user interface may also be provided at the requesting participant 104 to monitor search and download status and, for example, to receive user inputs such as a selection of one or more out of many responding participants 104 from which a download will be initiated.

One or more servers 106 may also be present in the file sharing network 100, depending on the particular file sharing technology in use. Prior to the emergence of peer-to-peer networks, file sharing typically occurred between users who would post to a searchable file transfer protocol (FTP) facility or news group that would store a copy of the shared content. More recently, centralized file sharing networks have used a server 106 to provide a centralized repository for indexes of content and locations, or simply IP addresses of participating nodes. For example, the popular BitTorrent protocol employs a “tracker”, which is a central server 106 that manages interconnections among participants 104 but carries no information about content being transferred among the participants 104. In other file sharing protocols, individual participants 104 provide an increasing amount of server-like functionality, including tracking the presence, quality, and content of neighboring participants 104 in the file sharing network 100. Participants 104 may even be enlisted in coordinating a download of a single media item from a number of different sources. Thus, it will be appreciated that participants 104 in many file sharing networks 100 may also be considered servers 106 with respect to their role in the network 100, and the use of the terms participant 104 and server 106 are both intended to encompass all such meanings unless another, specific meaning is clear from the context.

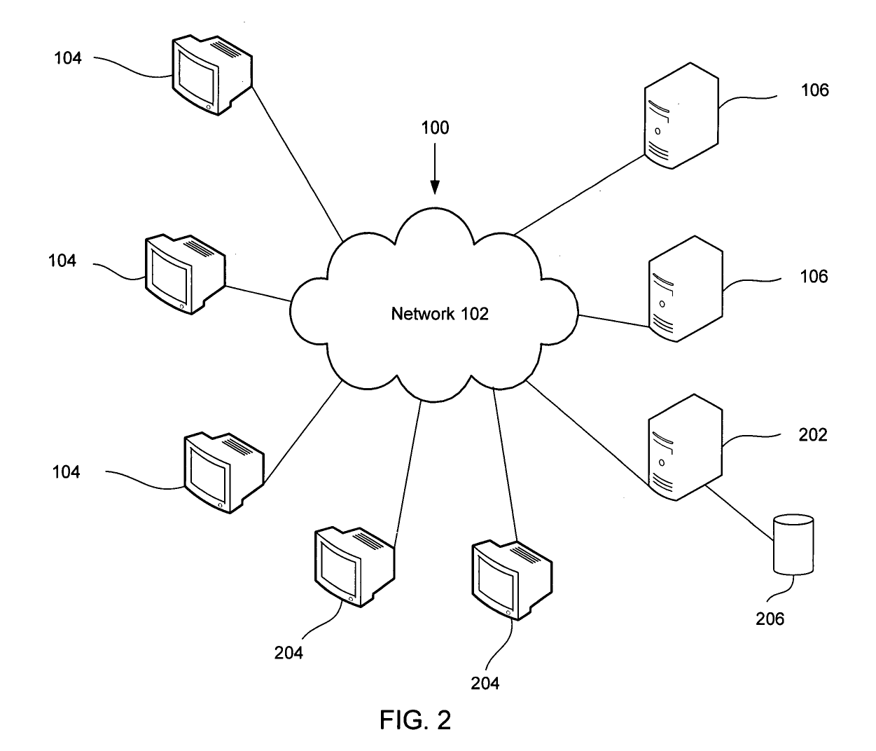

FIG. 2 shows a file sharing network with a source manager and agents. The file sharing network 100 may include a data network 102, participants 104, and one or more servers 106 as described above. In addition, a source manager 202 with a data facility 206 and one or more agents 204 may be employed to disrupt file sharing within the file sharing network 100. In embodiments, the agents 204 receive instructions from the source manager 202 that control operation of the agents 204 in disrupting distribution of one or more files through the file sharing network 100.

The source manager 202, which may be a personal computer, server, or other network device such as those described above, may perform a number of administrative functions to receive customer instructions and coordinate disruption of file distribution. For example, the source manager 202 may provide a web interface or other user interface for customers to provide instructions concerning media protection. The source manager 202 may also maintain a data facility 206 with a database of policies (media to be protected, file sharing networks to be addressed, level of disruption, etc.) and available agents 204, as well as metrics for evaluating results. The data facility 206 may include any combination of hardware and software for storing and retrieving data, including relational databases, volatile and non-volatile memories, network attached storage, and the like.

An individual, group, organization, or business may use the services of the source manager 202 on a fee basis to protect defined files from illegal file transfers. Fees may be established for varying degrees of disruption or for disruption over various ones of the known file sharing networks 100. Thus, for example, BitTorrent disruption may have one charge, and KaZaa disruption may have another charge, with fees set according to complexity of disruption, demands on resources of participating agents 204, popularity of particular file sharing networks, and so on. Thus, disruption services may be sold on an a la carte basis or in packages that provide reduced fees for certain groups of file sharing networks. In other fee schemes that may be used instead of, or in addition to these schemes, various levels of service such as silver, gold, platinum, and so on, may be provided. Additionally, discounts may be provided for disrupting a large number of titles or a group of titles having a common characteristic such as an artist or album.

Each agent 204 may run agent software downloaded from the source manager 202 or some other location, in combination with any configuration files or other data providing instructions to the agent 204 concerning particular file transfers that are to be disrupted within the file sharing network 100. In operation, an agent 204 may join the file sharing network 100 as a participant 104, and from that position within the network 100 the agent 204 may execute a disruption plan provided by the source manager 202. An agent 204 may disrupt file transfers using any number of techniques. For example, an agent 204 may, through appropriate interaction with a particular file sharing network 100, direct queries from other participants 104 to itself or to other agents 204 assisting with the disruption process. Optionally, the agent 204 may direct searches to other non-network resources, or provide lists of other available agents 204 as possible resources for further queries. Agents 204 may also queue search requests or file requests for extended periods or may respond to file requests with bogus or corrupted files that consume resources within the file sharing network 100 that are directed toward distribution of the media that is to be protected. The agents 204 may also be enlisted to promote legitimate distribution of protected media by forwarding participants 104 in the file sharing network 100 to a legitimate download site for the requested media.

An agent 204 may work in constant communication with the source manager 202, providing regular updates and receiving periodic changes to disruption instructions, or an agent 204 may operate autonomously over extended periods using locally stored instructions. It will be appreciated that, by distributing disruption tasks among a number of agents 204 that participate in the file sharing network 100 from frequently changing network addresses, detection of disruptive activity and adaptation thereto may become more difficult.

In certain embodiments, the techniques described herein may be realized as portable software that can be downloaded and, if necessary, installed on client devices. Such software may run in the background or in some other mode that is not intrusive into other uses of the agent 204 device. It may be beneficial to employ techniques for recruiting additional agents 204 and for providing incentives for existing agents 204 to participate regularly in deterrent activities. Users may be provided with incentives to download and install agent 204 software and to keep the software running regularly using any number of techniques such as cash payments, store credits, entries into lotteries or other gaming techniques, access to direct downloads of legitimate media, and so on. Further, a customer who pays for agent-based deterrent services may specify particular agent rewards for specific deterrent campaigns.

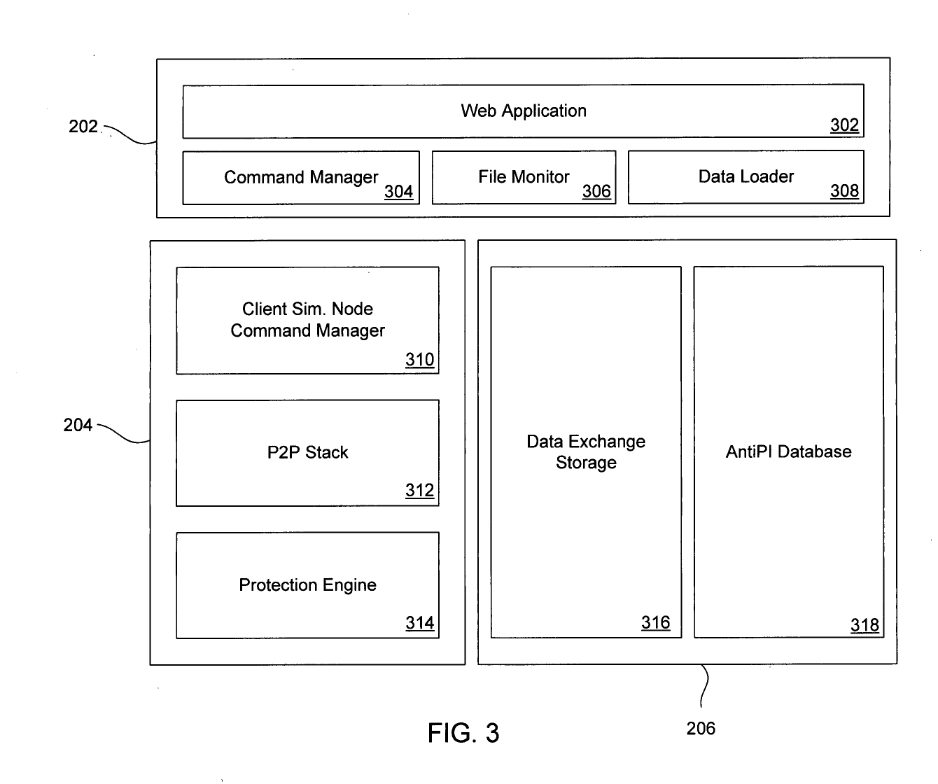

FIG. 3 is a block diagram of a software architecture for use in file sharing disruption. A source manager 202 such as the source managers described above may include a web application 302, a command manager 304, a file monitor 306, and a data loader 308. An agent, such as any of the agents 204 described above, may include a client simulation node command manager 310, a peer-to-peer protocol stack 312, and a protection engine 314. A data facility 206 such as the data facility 206 discussed above may include a data exchange storage 316 and an anti-piracy database 318. In certain embodiments, these software components cooperate with one another to provide control of a distributed file sharing deterrent system in which agents 204 are enlisted and directed by a source manager 202 to individually or cooperatively engage in disruptive behavior focused on particular media of interest to customers of the system.

The web application 302 of the source manager 202 may provide a web-based interface for customers of the deterrent system described herein. Through the interface provided by the web application 302, a customer may specify content searches and protection policies and may review statistics on the effectiveness of current deterrent policies. The web application 302 may also provide an administrative console for managing agents 204, checking system performance and health, and obtaining operational reports and statistics.

The command manager 304 may serve as a central point of communication between agents 204 and a source manager 202. The command manager 304 may retrieve operational information from the data facility 206 and apply the information to interact with agents 204 and provide appropriate deterrent policy instructions. The command manager 304 may interact with agents 204 in various ways including obtaining agent 204 status, pushing configuration information to agents 204, analyzing availability of agents 204, coordinating search engine requests, pushing specific deterrent policies to agents 204, collecting alerts, managing one or more instances of the data loader 308, and controlling installation and upgrades of agent software.

The file monitor 306 may monitor a temporary storage file drop location in the source manager 202 for new files, such as files containing updates from agents 204, and assign them to data loaders 308. When each new file is posted to the appropriate location, the file monitor 306 may assign the file to a data loader 308, such as on a next-available basis.

The data loader 308, of which there may be several or many instances in a source manager 202, may transform data generated by agents 204 into a form suitable for the data facility 206. For example, agents 204 may provide data as an XML stream, and the data facility 206 may store data in a relational database. Before such data can be used, such as for status updates through the web application 302, the data must be transformed and stored. A data loader 308 instance may handle a single data file at time, as assigned by the file monitor 306 or other system components. A data loader may, for example, handle search results, statistics on execution of deterrence policies, agent 204 computer system events, errors, and any other information that might be reported from agents 204.

The client simulation node command manager 310 of the agent 204 may maintain a communicating relationship with the source manager 202 so that the agent 204 may receive instructions or deterrent policy data from the source manager 202, and it may provide status updates, alerts, and information about a file sharing network 100 to the source manager 202. The communicating relationship may include a secure data connection using, for example, Secure Shell (SSH), Secure Socket Layer (SSL) or any other protocol or system for maintaining secure communications over the Internet. The communicating relationship may also, or instead, include electronic mail communications, which may also be secured or encrypted using a number of techniques that may be automatically generated, received, and/or interpreted by either an agent 204, a resource manager 202, or both. In certain configurations, a secure command interface such as SSH may be used for routine communications, and electronic mail may be used for errors or other alerts.

Under control of the client simulation node command manager 310, and following any policies, data, or instructions received from the source manager 202, an agent may execute a deterrent policy on a peer-to-peer network. An agent may be autonomous, so that it may continue execution of a deterrent program without constant communication with the source manager 202. Similarly, the command manager 306 may auto-load when an agent 204 computer system is powered up or booted, and it may execute then-resident deterrent policies until other commands are received from the source manager 202.

Two functions may be broadly associated with the task of executing deterrent policies: (1) searching a peer-to-peer network for media that are to be protected and (2) using available countermeasures to prevent or deter sharing of the media through the peer-to-peer network. More specifically, the command manager 306 may control an agent 204 to launch local search and protection engines, manage configuration, report error events to the source manager 202, report event logs to the source manager 202, transmit statistics to the source manager 202, transmit search results to the source manager 202, and send search results to the source manager 202. The command manager 306 may also control installation and updates of agent software.

The peer-to-peer protocol stack 312 may implement one or more specific peer-to-peer or other file sharing network protocols. The protocol stack 312 may provide generic peer networking capabilities and features that can be user-configurable (or configurable remotely by the source manager 202) for participation in selected networks. The stack 312 may interact with a file sharing network 100 and make the agent 204 appear as a participant in the network 100. More than one instance of the peer-to-peer protocol stack 312 may execute on a single agent 204, as appropriate to the deterrent policy being implemented by the agent 204. The protection engine 314 may conduct searches and deterrent activities by communicating with a file sharing network 100 through the peer-to-peer protocol stack 312.

The protection engine 314 may execute a protection policy defined by a customer of a file sharing deterrent service. The protection engine 314 may be launched on an agent 204 and execute a deterrent policy using locally stored information or information received from a source manager 202. The protection engine 314 may generally control execution of a protection policy by an agent 204 and creation of any protection statistics.

The protection engine 314 may also control searches of a file sharing network 100 performed by an agent 204 through the peer-to-peer protocol stack 312. In particular, the protection engine 314 may execute search requests in the network 100 as defined by customers and store results that match any user-provided search criteria. Searches may be requested and controlled by commands from the source manager 202. In addition to providing search results to the source manager 202, the protection engine may create result lists that include specific files found and any attributes of those files.

Searches may be user-specified according to any number of parameters. For example, a customer may specify a title, such as an audio CD title or DVD movie title. A customer may also specify media according to content, such as specific audio tracks or game program modules. More generally, content searching may employ any searchable attributes of media. Customer search requests may be directed toward previous search results stored in the data facility 206, or they may be directed toward new searches of a file sharing network 100. When a customer chooses a network search, the source manager 202 may store the search definition in the system database and schedule the search for execution. A customer may also create multiple searches to track the status of content over time or request time-based reporting of search results. In order to execute a search, the source manager 202 may parse a search request provided by a customer and distributes the search to agents 204, each of which conducts a search under control of the protection engine 314 and returns the results to the source manger 202. Interim progress reports may also be provided. A customer may browse search results through a web browser that accesses the web application 302 of the source manager 202. Through this interface, a customer may tag files and/or associate them with certain content or media, thus identifying them as files used within the file sharing network 100 to distribute the specified content.

Searching functions may be usefully integrated with disruption functions of the protection engine 314. Once search results have been reviewed by a customer and associated with content, the customer may initiate a sharing deterrent program based upon the content of interest, rather than based upon a list of specifically enumerated file names shared within the file sharing network 100. Protection policies for particular content may include a period of protection, file sharing networks 100 covered, types of deterrent activity, and so on. A protection policy may be stored in the data facility 206 for subsequent dissemination to agents 204.

The data exchange storage 316 of the data facility 206 may function as a back-end database for the deterrent system and may communicate with agents 204 and customers (through the web application 302) to configure deterrent programs and maintain status and other information for ongoing programs, including storage of any alerts or messages from participating agents 204.

The anti-piracy database 318 may store information used during operation of the system, including defined content searches, search results, content protection policies, content protection statistics, customer and user information, system configuration information, and operation data. Feedback on system performance provided to customers may include, for example, search results for completed searches, statistics on files or content protected for one or more (customer or system specified) reporting periods, and event logs for individual agents 204. Data from individual agents 204 may be gathered and centralized for the data loader 308 as described generally above.

It will be appreciated that the components described above correspond generally to various areas of functionality for the participants in a file sharing deterrent system. However, in various embodiments, other components may be added, or certain components may be removed or combined with other components. For example, the protection engine 314 may be divided into two separate and independently operating engines: a policy execution engine and a search engine. Similarly, the data loader 308 and file monitor 306 may be combined into a single data-handling component. Any number of such combinations and variations may be employed consistent with the systems described herein.

It will also be appreciated that a wide range of software and hardware platforms may be used to deploy the above-described components of the agents 204, source managers 202, and data facilities 206. Generally, the components may be realized in hardware, software, or some combination of these. The components may be realized in one or more microprocessors, microcontrollers, embedded microcontrollers, programmable digital signal processors or other programmable devices, along with internal and/or external memory such as read-only memory, programmable read-only memory, electronically erasable programmable read-only memory, random access memory, dynamic random access memory, double data rate random access memory, Rambus direct random access memory, flash memory, or any other volatile or non-volatile memory for storing program instructions, program data, and program output or other intermediate or final results. The components may also, or instead, include an application-specific integrated circuit, a programmable gate array, programmable array logic, or any other device or devices that may be configured to process electronic signals in a manner consistent with the systems and methods described herein.

Any combination of the above circuits and components, whether packaged discretely, as a chip, as a chip set, or as a die, may be suitably adapted to use with the systems described herein. It will further be appreciated that the above components may be realized as computer executable code created using a structured programming language such as C, an object oriented programming language such as C++, or any other high-level or low-level programming language that may be compiled or interpreted to run on one of the above devices, as well as heterogeneous combinations of processors, processor architectures, or combinations of different hardware and software.

In addition to the architecture of a file sharing deterrent system, certain methods for deterring distribution of specified files are now described in greater detail. For each of the methods set out below, any of the combinations of hardware and/or software described above may be used to implement the processes and are intended to fall within the scope of this disclosure.

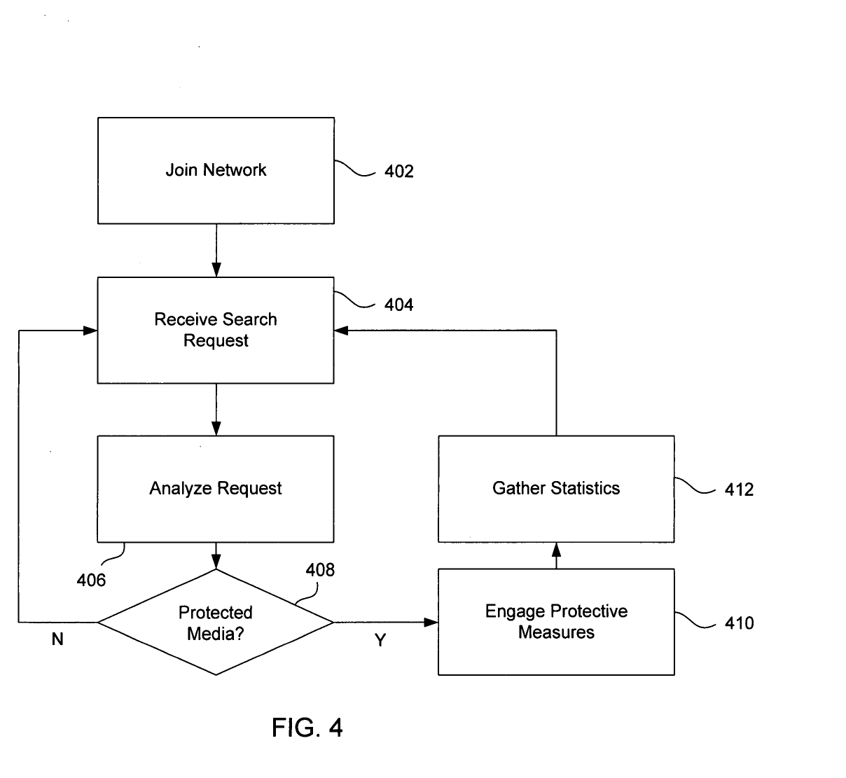

FIG. 4 shows a flow chart of a file sharing deterrent process that may be used with the systems described herein. In certain embodiments, the deterrent effect of the process 400 is achieved by capturing search requests received through the file sharing network 100 and preventing them from reaching (illegitimate) copies of the requested content.

As shown in step 402, a deterrent process 400 may begin when an agent joins a file sharing network as a participant, as described generally above. As noted above, the manner in which the network is joined may vary from protocol to protocol and among specific instances of a protocol. As a general matter, the agent would make other participants in the network aware of its presence, such as by sharing its IP address with predetermined participants, and may provide additional information such as other valid IP addresses within the network.

As shown in step 404, a search request may be received by the agent from another participant in the network. While search requests are a common function in file sharing networks, it will be appreciated that other functions may be available to participants, including various query (e.g., what files does a participant have for sharing), copy, move, and delete functions as well as more general functions relating to investigation of the network itself. In such instances, an agent may employ different tactics from those described below to more efficiently disrupt network traffic in particular content, and all such techniques are intended to fall within the scope of this disclosure. Upon receipt of a search request, the process 400 may proceed to analyze the search request.

As shown in step 406, the search request may be analyzed. In this analysis, the content of the request may be examined and compared to data maintained by the agent concerning media to be protected. This may include identification of file names, content metadata such as author or artist names, song titles, digital watermarks, digital object identifiers, file characteristics, and so on. While file names represent one straightforward technique for evaluating search requests, more sophisticated techniques for indexing and characterizing files continue to emerge, such as hashing, profiling, frequency content analysis, compression characteristics, and so on. The analysis of step 406 may employ any or all such techniques, and any other techniques that can be usefully employed to identify searches for protected media in a file sharing network, and all such techniques are intended to fall within the scope of this disclosure.

As shown in step 408, a determination may be made as to whether a particular search request is for protected media (as specified by a customer through the source manager). If the search request is not for protected media, then the process 400 may return to step 404 where the next search request is received. If the search request is identified as relating to protected media, then the process 400 may proceed to step 410.

As shown in step 410, protective measures may be engaged by an agent against proliferation and sharing of the protected media in the file sharing network. A number of different protective measures may be employed by the process 400, and protective measures may further be coordinated with other agents wherever the nature of a request, and the nature of the particular file sharing network, permit performance advantages to be realized from the combined deterrent effort. Some example protective measures for deterring file sharing of protected media are described below, although it should be appreciated that wherever participants employ criteria for evaluating media or sources of media, those criteria may be manipulated within the file sharing network so that an agent can reply to participants with favorable information to make itself (or other agents) more attractive destinations for searches and/or downloads.

In one protective technique, the agent effectively pretends to have a copy of the requested media. The agent may generate a reply to the requester indicating that a copy of the requested file or, more generally, a file having a good match to the search request parameters is present at the agent. Where a search request is followed by a download request from the requester to the agent, the agent may synthesize a file which conforms to the search parameter(s) but is otherwise useless. For example, where a search is for an artist's name, the agent may create (or retrieve from storage, if decoy media is prefabricated) a file having a title or corresponding metadata containing the artist's name, a song title for a song written by the artist, and any other metadata or other descriptive information used by the file sharing network. The bogus file may be assigned properties and file extensions giving an appearance of legitimacy, and may be filled with data to achieve an appropriate size, such as random data, white noise, preselected content (such as a regular pattern of ones and zeros, or media that renders in the requested audio-visual format, such as a pure tone or a blank screen), or any other random or structured data. The bogus file may also, or instead, use pieces of the requested work such as an introductory segment or an otherwise corrupted copy of the original.

The process 400 may also employ a degree of feedback. For example, where a particular song title by a particular artist is commonly requested, the source manager may seed all participating agents with a bogus version of that media so that a number of copies of that media appear to be continually available from a number of high-quality sources.

In another technique adapted to certain file sharing networks, the agent may provide a reply that it knows a location of the requested work or of other nodes in a peer network that can expand a search. In such cases, a mock list of locations and/or filenames may be provided, and in certain file sharing networks such a list may be propagated to other participants beyond the requester, thus enhancing the effectiveness of deterrence. Where a file sharing network permits, the agent may redirect a requester to any number of locations, such as a non-existent location, a location that will form a connection but will not respond to requests, a location with information about legitimate media sources, or a location that is a legitimate source of the requested media.

In another technique, in response to a search request, the agent may generate a reply to the requester that points to an irrelevant media file published by another P2P participant. As a result, at least one additional participant of a P2P network may spend resources on transmission of undesirable and unprotected media.

In another technique adapted to certain file sharing networks, the agent may employ falsified hashes to improve deterrence with certain identification facilities. In some file sharing networks, participants may use hash functions to generate shorthand digital indicia for accurate file identification. In such networks, the agent may specifically attribute a hash value to a bogus file according to a value expected for a true copy of the requested media.

In another technique adapted to certain file sharing networks, an agent may present information that characterizes the quality of a requested file. The quality of the file may be based on a quality of a network connection for the participant storing the file, such as bandwidth, latency, availability, up time, actual or anticipated data transmission rates, and so on. The quality of the file may also, or instead, relate to a quality of the media itself, such as sampling rate, sampling bits, audio bandwidth, and the like. An agent may dynamically generate file quality information to entice participants to request downloads from that agent or may use file quality information specified by a source manager.

The above techniques may also be combined to most effectively capture download requests in a file sharing network. Incoming search requests may be parsed to identify particular search parameters and keywords for the request. The agent may respond with a file description tailored to closely match the search parameters, thus ranking highly in the requesting participant's results. Thus, if a search specifies an artist, a minimum audio quality, and a minimum length, results may be returned that equal or exceed each of the search parameters. An agent may further create a bogus file or part of a file that closely matches the search criteria and may provide the file to the participant in response to a download request. In an embodiment, only a disjointed part of a file may be provided to a requester. As result, a file transfer operation will never be completed and a requester may have no opportunity to verify correctness of the requested file and re-request it from another source. More generally, where a file sharing network uses ranking, either by a requesting participant who calculates rankings of search results or by a responding participant that provides a corresponding file parameter, these rankings may be manipulated to steer participants toward downloads from agents rather than other non-agent network participants. For example, the source manager or an agent may analyze related files available through the file sharing network and synthesize files that will have higher rankings using established ranking techniques for the network. In another configuration, rankings for synthesized files or metadata may be adjusted to fall within certain percentile ranges (top 10%, second 10%, top 20%, and so on) to appear more like other instances of protected media available throughout the file sharing network.

Where participants become aware of agent activity, it may be desirable to cause rankings somewhere below the top percentiles based upon keyword matching, connection quality, file quality, and so on. In other words, participants may ignore rankings in the top 1%, the top 5%, or any other percentile or other ranking where such high-ranking results are believed to be synthesized. Anti-piracy activity may be readily adapted to such user behavior using the systems described herein by purposefully generating rankings that are at some predetermined ranking that is below the top, but nonetheless attractive, e.g., the range from 10^{th} percentile to 20^{th} percentile.

In another approach related to media rankings, participants or a centralized computer may rank other participants according to, e.g., connectivity attributes or upload/download ratios. For example, BitTorrent uses a centralized server for coordinating connections among peers and may provide positive evaluations for participants that frequently share files with others. This characteristic may additionally be used to allocate greater resources within the file sharing network to the perceived contributor. In such networks, a number of agents may join the network and share numerous files among themselves through the network to enhance objective sharing metrics and to make the agents appear to be regular contributors within the network.

In another technique adapted to certain file sharing networks, an agent may indefinitely queue a request for download. That is, after an agent has successfully elicited a download request from a participant in a file sharing network, the agent may do nothing but hold the download connection, thus delaying subsequent search and download activity by the participant.

In another technique adapted to certain file sharing networks, an agent may redirect a search or download request to another agent or a server that provides legitimate media. In such cases, a fee may be charged by the entity operating the network of distributed agents to the operator of the site that provides the legitimate media, such as an advertising or referral fee. In addition, a participant may be fined for attempted unlawful activity. Although such a fine may be difficult to collect in a commercial setting from an unwilling participant, the fine may be convertible into a discount on legitimate media, thus providing an incentive to the participant to lawfully acquire the media sought. Redirection may occur either explicitly, so that a participant is aware of the redirection, or implicitly, so that the participant does not realize that any redirection has taken place. Additionally, where redirection of search requests is possible, a number of redirections may be chained together to delay receipt of search results and/or downloads from agents while giving an appearance of productive network activity.

In another technique, disrupting file sharing of protected media may include attracting P2P customers to paid media with built-in digital rights managements (DRM) and payment procedure, such as Microsoft® Windows media.

In another technique adapted to certain file sharing networks, an agent may respond to a search request by simulating the presence of a number of other participants having the protected media. The simulated participants may be fictitious, such that the requesting participant will proceed to directly query a number of non-existent addresses, or the simulated participants may be other agents that appear to have high-quality copies of the protected media.

Other disruptive techniques may include measures intended to induce conduct by human users. Thus, for example, messages may be embedded in audio or video media files created by agents or may be provided on web sites or other network locations to which a participant is redirected. The messages may provide incentives for purchase of legitimate media corresponding to a search request, such as discount coupons or store credits. The messages may also, or instead, provide disincentives to pursuing illicit activity, such as copyright notices. And messages may notify a participant of possible fees or fines. For example, a message to a participant for a captured search may strike an ominous tone using information readily available from an Internet connection in a dynamically generated media file or web page as follows:

WARNING: We have registered an attempt to download copyrighted material from your IP address xxx.xxx.xxx.xxx at yy:yy:yy p.m. on dd/dd/dd. If you do not provide proof of legitimate ownership of this media or pay a fine of $$ within ten days, we will seek identifying information for this IP address from your Internet Service Provider and pursue all remedies available under U.S. copyright law. For further information, visit our website at . . . .

Thus a disincentive for wrongful activity, such as a fine or threat of criminal proceedings, may be combined with an incentive for proper behavior, such as a discount on legitimate media to achieve greater impact on participants with captured searches. Note that the form of notice above is merely suggested, and numerous variations may be considered according to factors such as local laws or customs, desired impact on peer network users, and preferences of individual deterrence service customers (e.g., copyright owners). More generally, it will be appreciated that personalized messages may be generated for file sharing network participants based upon readily available information such as the participant's IP address, an Internet Service Provider for the IP address (if any), and possibly additional information such as a user name, e-mail address, or profile.

After engaging in any or all of the above deterrent measures to hinder or disrupt distribution of protected media in a file sharing network, the system may gather any relevant statistics as shown in step 412 and return to step 404 where a new search request may be received and processed.

It should be appreciated that, while a specific order of steps is shown in FIG. 4, numerous variations and alterations are possible and may be usefully employed with the systems described herein. For example, statistics may be accumulated at any point throughout the repeating process 400 and may be reported to a source manager for overall improvement of the process 400. Further some steps may be repeated in parallel. For example, separate threads (or other multi-tasking or quasi-multi-tasking techniques) may be employed to receive additional search requests while one request is being processed. In view of the high traffic volume of some file sharing networks, it may be desirable to increase the number of processing threads to a maximum consistent with other operations of a device hosting the agent software. All such variations and improvements that would be recognized by one of ordinary skill in the art are intended to fall within the scope of the process 400 described above.

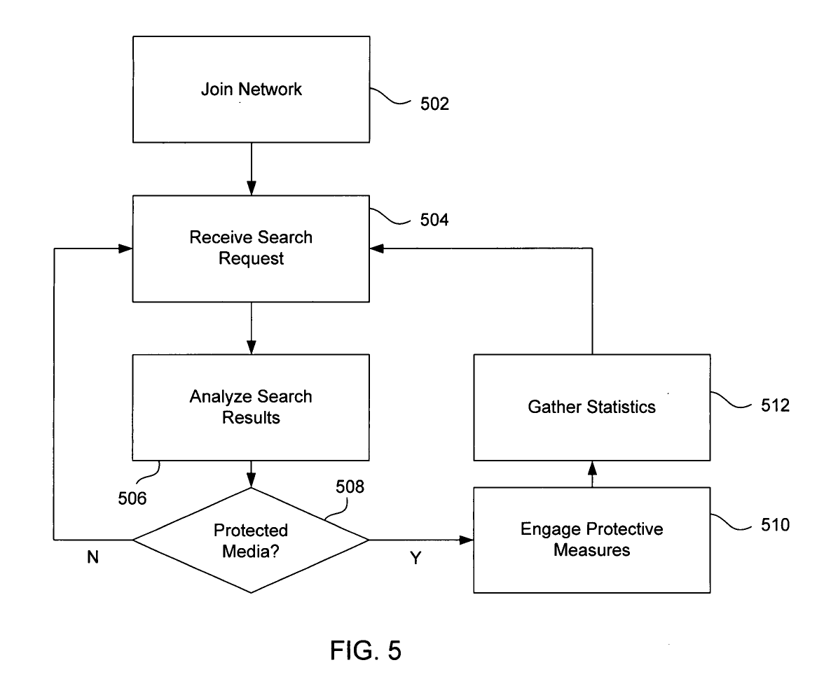

FIG. 5 shows a flow chart of a file sharing deterrent process using search requests issued by an agent. The process 500 may begin with step 502 where an agent joins a file sharing network as a participant. This may be, for example, as described above with reference to step 402 of FIG. 4.

Once the agent has joined a network, the process 500 may proceed to step 504 where the agent issues a search, typically a predetermined search intended to identify protected media within the file sharing network.

In step 504, the agent may issue a search request to the file sharing network. The search request may use any and all search parameters provided by the file sharing network to identify protected media. The search may occur in two or more phases. For example, a first search may broadly identify potentially relevant content. The results of the first search may be reported to a source manager and then presented to a customer through a web browser as described generally above. The customer may then specify file names or other attributes related to protected media for which specific deterrent policies are desired. These customer indications may be pushed back to one or more agents for subsequent real-time searching using more tightly prescribed search attributes.

In step 506, the agent may analyze search results received from the file sharing network. In particular, the agent may try to identify files or collections of files available from other participants in the file sharing network that contain protected media, or that appear to contain protected media, designated by a customer.

In step 508, a determination is made whether protected media have been identified. If unprotected media have been identified, the process 500 may return to step 504 and one or more additional searches may be issued by the agent.

If protected media are identified, the process may proceed to step 510 where protective measures are engaged. In one technique adapted to certain file sharing networks, the agent may hinder access to the protected media by issuing a stream of download requests or search requests to the participant along with the media, thus filling the participant's queue and denying or reducing access to other participants. This technique may be enhanced by enlisting numerous agents, either autonomously or through coordination by a source manager, to simultaneously request the protected media from the participant, effectively crowding out other participants in the file sharing network.

In another technique adapted to certain file sharing networks, full queues may be simulated by informing other participants that the queue of a particular participant with the protected media is full.

In another technique adapted to certain file sharing networks, the participant with the protected media may be flooded with related searches or fictitious search responses that make it difficult to identify accurate results for the protected media.

As shown in step 512, any relevant statistics may be gathered on operation of the agent and effectiveness of deterrent measures, and the process 500 may return to step 504 where the agent may issue a new search request.

It should be appreciated that, while a specific order of steps is shown in FIG. 5, numerous variations and alterations are possible and may be usefully employed with the systems described herein. For example, statistics may be accumulated at any point throughout the repeating process 500 and may be reported to a source manager for overall improvement of the process 500. Further some steps may be repeated in parallel. For example, separate threads (or other multi-tasking or quasi-multi-tasking techniques) may be employed to generate additional search requests while other search results are being analyzed. In view of the high traffic volume of some file sharing networks, it may be desirable to increase the number of processing threads to a maximum consistent with other operations of a device hosting the agent software. All such variations and improvements that would be recognized by one of ordinary skill in the art are intended to fall within the scope of the process 500 described above.

It should be generally understood that there are other variations to blocking, decoying, or spoofing, as well as other techniques to deter sharing of protected media that may be used separately by agents or combined with other techniques disclosed herein to achieve improved deterrent effect.

For example, an agent may capture and respond to a search for protected media while a blocking technique is simultaneously employed to diminish access to the media stored on participant devices. At the same time a decoy may be used to present simulated copies of protected media to the network. The combined action of these techniques may improve overall performance of the deterrent system. Further, it should also be understood that different agents may employ different techniques, or combinations of techniques, as part of a single deterrent campaign. At the same time, a single agent device may participate in a number of different deterrent campaigns at the same time, including a number of different campaigns for a common customer, different campaigns for different customers, or combinations of these.

In embodiments, the systems described herein employ a number of distributed agents to hinder ordinary search and download activity within a file sharing network and, in particular embodiments, activity relating to specific, identified media. All such variations and improvements to the methods and systems described above that may be usefully employed for the same or similar purposes are intended to fall within the scope of this disclosure. The scope of the invention is not to be limited by any of the specific examples provided above but, rather, should be limited only by the following claims, which should be interpreted in the broadest sense permitted by law.

1-30. (canceled)

31. A method of protecting content in a file sharing network comprising:
receiving a request from a participant in a file sharing network at one of a plurality of distributed agents;
analyzing the request to determine a corresponding hash value for content responsive to the request;
simulating an object with the corresponding hash value; and
presenting the simulated object to the participant for download.

32. The method of claim 31 wherein simulating the file includes using signaling of
the file sharing network to indicate presence of the object at one or more of the plurality of distributed agents.

33. The method of claim 31 wherein the simulated object is an actual file on one or more of the distributed agents.

34. The method of claim 31 wherein the simulated object does not exist.

35. The method of claim 31 wherein the simulated object is dynamically generated.

36. The method of claim 31 wherein the simulated object includes an object containing an instruction.

37. The method of claim 36 wherein the instruction directs the participant to a legitimate source for the simulated object.

38. The method of claim 37 further comprising charging a fee for directing the participant to the legitimate source.

39-77. (canceled)

78. A system for deterring file sharing comprising:
a plurality of distributed agents within a file sharing network;
a first participant that issues a request for protected media to one of the plurality of distributed agents; and
a transmission facility that responds to the request by transmitting other media different from the protected media to the participant.

79. The system of claim 78 wherein the other media is dynamically generated.

80. The system of claim 78 wherein the other media directs the participant to a legitimate source of the protected media.

81. The system of claim 78 wherein the other media are predetermined media stored at the one of the plurality of agents.

82. The system of claim 78 wherein the other media are adapted to receive a high ranking in a search request for the protected media.

83. The system of claim 78 wherein the other media include one or more indicia that they are the protected media.

84. The system of claim 83 wherein the one or more indicia include a hash value.

85. A system for protecting content in a file sharing network comprising:
a facility for receiving a request from a participant in a file sharing network at one of a plurality of distributed agents;
a hash determining facility for determining a corresponding hash value for content responsive to the request; and
an object generation facility for generating a simulated object with the corresponding hash value; and presenting the simulated object to the participant for download.

86. The system of claim 85 wherein generating the simulated object includes using signaling of the file sharing network to indicate presence of the object at one or more of the plurality of distributed agents.

87. The system of claim 85 wherein the simulated object is an actual file on one or more of the distributed agents.

88. The system of claim 85 wherein the simulated object does not exist.

89. The system of claim 85 wherein the simulated object is dynamically generated.

90-119. (canceled)
